(19) United States
(12) Patent Application Publication
(10) Pub. No.: US 2019/0111585 A1
(43) Pub. Date: Apr. 18, 2019

(54) HIERARCHICAL COMPOSITIONS FOR THE ADDITIVE MANUFACTURING OF MATERIALS

(71) Applicant: The Texas A&M University System, College Station, TX (US)

(72) Inventors: Chao Ma, Bryan, TX (US); Zhijian Pei, College Station, TX (US); Xiaorui Ren, Houston, TX (US); Wenchao Du, College Station, TX (US)

(73) Assignee: The Texas A&M University System, College Station, TX (US)

(21) Appl. No.: 16/161,580

(22) Filed: Oct. 16, 2018

Related U.S. Application Data
(60) Provisional application No. 62/572,740, filed on Oct. 16, 2017.

(51) Int. Cl. B28B 1/00; B33Y 70/00; B33Y 10/00

(52) U.S. Cl. CPC B28B 1/001; B33Y 10/00; B33Y 70/00

(57) ABSTRACT

Embodiments of the present disclosure pertain to compositions comprising particles and a binding material, where the binding material and at least some of the particles are breakably associated with one another to form bound particles. Additional embodiments of the present disclosure pertain to methods of making the compositions by associating particles with a binding material such that the binding material and at least some of the particles become breakably associated with one another to form bound particles. Further embodiments of the present disclosure pertain to methods of additively manufacturing a material on a surface by (a) applying said bound particles onto the surface; (b) breaking at least some of the bound particles into particles; (c) applying an adhesive material onto the surface; and (d) treating the particles and any remaining bound particles to form the additively manufactured material. Additional embodiments pertain to the formed additively manufactured materials.

### CROSS-REFERENCE TO RELATED APPLICATIONS

This application claims priority to U.S. Provisional Patent Application No. 62/572,740, filed on Oct. 16, 2017. The entirety of the aforementioned application is incorporated herein by reference.

### BACKGROUND

Various materials are more difficult to process than other materials through additive manufacturing technologies. For instance, ceramic materials are more difficult to process than metals and polymers using additive manufacturing technologies because of their high melting temperature and brittleness. Various aspects of the present disclosure address the aforementioned problem.

### SUMMARY

In some embodiments, the present disclosure pertains to compositions that include particles (e.g., particles with diameters of less than about 1 μm) and a binding material. The binding material and at least some of the particles in the composition are breakably associated with one another to form bound particles (e.g., particles with diameters of more than about 1 μm).

In some embodiments, the bound particles in the composition are loosely agglomerated to one another. In some embodiments, the composition includes a granulated structure. In some embodiments, the particles in the composition provide high sinterability while the bound particles in the composition provide high flowability.

In further embodiments, the present disclosure pertains to methods of making the compositions of the present disclosure by associating particles with a binding material such that the binding material and at least some of the particles become breakably associated with one another to form bound particles. In some embodiments, the associating occurs by methods that include, without limitation, mixing, grinding, milling, spray drying, spray freeze drying, and combinations thereof.

In additional embodiments, the present disclosure pertains to methods of additively manufacturing a material on a surface by (a) applying bound particles onto the surface, where the bound particles include particles breakably associated with one another through binding materials; (b) breaking at least some of the bound particles into particles; (c) applying an adhesive material onto the surface; and (d) treating the particles and any remaining bound particles to form the additively manufactured material. In addition, the additive manufacturing methods may occur by various processes, such as binder jetting.

In additional embodiments, the present disclosure pertains to the formed additively manufactured materials. In some embodiments, the formed additively manufactured materials include a densely sintered body without visible pores or cracks. In some embodiments, the additively manufactured material includes a relative sintered density of at least about 80% or at least about 85%. In some embodiments, the additively manufactured material includes a sintered density of at least about 3 g/cm³ or at least about 3.5 g/cm³. In some embodiments, the additively manufactured material includes a hardness of at least about 10 GPa or at least about 15 GPa.

### FIGURES

FIGS. 1A-1C provide a scheme of a method of making a composition (FIG. 1A), an illustration of the formed composition (FIG. 1B), and a scheme of utilizing the composition in additive manufacturing (FIG. 1C).

FIG. 2 provides a scheme of a lab-designed binder jetting additive manufacturing setup and process.

FIG. 3 provides a debinding and sintering temperature-time profile for printed samples.

FIGS. 4A-4B provide images illustrating the morphologies of fine powders (FIG. 4A) and granulated powders (FIG. 4B).

FIGS. 5A-5B provide images illustrating the morphologies of a granule (FIG. 5A) and coarse particles (FIG. 5B).

FIGS. 6A-6C provide images relating to the appearances of sintered samples made with coarse powder (FIG. 6A), fine powder (FIG. 6B), and granulated powder (FIG. 6C).

FIGS. 7A-7F provide images relating to the microstructure of sintered samples from granulated powders (FIGS. 7A and 7D), fine powders (FIGS. 7B and 7E), and coarse powders (FIGS. 7C and 7F).

### DETAILED DESCRIPTION

It is to be understood that both the foregoing general description and the following detailed description are illustrative and explanatory, and are not restrictive of the subject matter, as claimed. In this application, the use of the singular includes the plural, the word “a” or “an” means “at least one”, and the use of “or” means “and/or”, unless specifically stated otherwise. Furthermore, the use of the term “including”, as well as other forms, such as “includes” and “included”, is not limiting. Also, terms such as “element” or “component” encompass both elements or components comprising one unit and elements or components that include more than one unit unless specifically stated otherwise.

The section headings used herein are for organizational purposes and are not to be construed as limiting the subject matter described. All documents, or portions of documents, cited in this application, including, but not limited to, patents, patent applications, articles, books, and treatises, are hereby expressly incorporated herein by reference in their entirety for any purpose. In the event that one or more of the incorporated literature and similar materials defines a term in a manner that contradicts the definition of that term in this application, this application controls.

Ceramic materials have outstanding material properties, such as extraordinary high-temperature stability, excellent hardness and wear resistance, and exceptional biocompatibility. However, it is very expensive to fabricate ceramic parts of complex shapes using conventional manufacturing techniques. For conventionally fabricated ceramic parts with complicated geometries, the tooling cost can be up to 80% of the overall cost [1], leading to excessive cost of prototypes and difficulties in changing the design.

Additive manufacturing (AM), also known as three-dimensional (3D) printing, can be described as the process of joining or adding materials with the primary objective of making objects from 3D model data using the layer-by-layer principle. Additive manufacturing creates final shapes by the addition of materials, unlike conventional manufacturing techniques, such as machining and forging, which fabricate products by removing materials from a larger stock or deforming materials from an original work piece. During the additive manufacturing fabrication processes, no special tooling is needed [2,3]. Other advantages of additive manufacturing processes include flexible and customized design and efficient usage of raw materials.

One ceramic additive manufacturing method that has been extensively investigated is binder jetting. Since the first presentation of ceramic binder jetting, many experiments have been investigated and copious parts have been produced [4-10]. Binder jetting is the most promising method to produce large high-density ceramic parts among all additive manufacturing technologies because other processes use a large fraction (˜50 vol. %) of polymeric binder and a complete burning of the binder requires at least one dimension to be thin.

Nonetheless, none of the existing research in ceramic binder jetting has achieved a high relative density. Due to the low relative density, the mechanical properties of ceramic components made by ceramic binder jetting do not meet the specifications for most load-bearing applications, such as joint implants [11]. Nowadays, the achievable density on various ceramic materials by binder jetting is as low as 23-73% [7, 10-17], as Table 1 shows.

TABLE 1
The relative sintered density of existing
materials made by binder jetting.

| Material | Relative sintered density (%) | References |
|---|---|---|
| Alumina | 38-67 | [7, 13, 20, 21] |
| Tricalcium phosphate | 39-73 | [14-17, 22-24] |
| Barium titanate | 23-65 | [4, 18] |
| Silicon carbide | 24-32 | [25] |
| Titanium carbide | 34-45 | [19, 26, 27] |

Flowability and sinterability are two important powder properties that determine the material properties of parts from binder jetting technology. Fine powder has high sinterability due to its large surface area and low flowability due to its large inter-particle friction. By contrast, coarse powder has low sinterability and high flowability. The contradiction between flowability (large particles required) and sinterability (small particles required) is one of the main causes for the relatively low density of fabricated parts by binder jetting technologies.

There exists scattered reports on granulated powders for binder jetting additive manufacturing in the literature [13,28-33]. Most of these studies were aimed at scaffolds for bone tissue engineering. The enhancement of density was not the focus of these studies.

Furthermore, more attention has been drawn on the additive manufacturing of ceramic materials since additive manufacturing can overcome the poor machinability nature of ceramic materials. Unlike other kinds of materials, additive manufacturing of ceramics usually requires a subsequent sintering process to densify the ceramic components.

The granulated powder in the previous reports consists of firmly bound particles, which did not increase (and even might have decreased) the density in the binder jetting process. For example, in Ben et al's work [33], the bonding between particles was so strong that a pressure as high as 80 MPa was needed to break the agglomerates. Still, only an apparent solid density of 65% was achieved using cold pressing.

As such, a need exists for the development of improved powders for additive manufacturing that have both high flowability and high sinterability. A need also exists for the development of additively manufactured materials that have optimal hardness and densities. Various aspects of the present disclosure address the aforementioned needs.

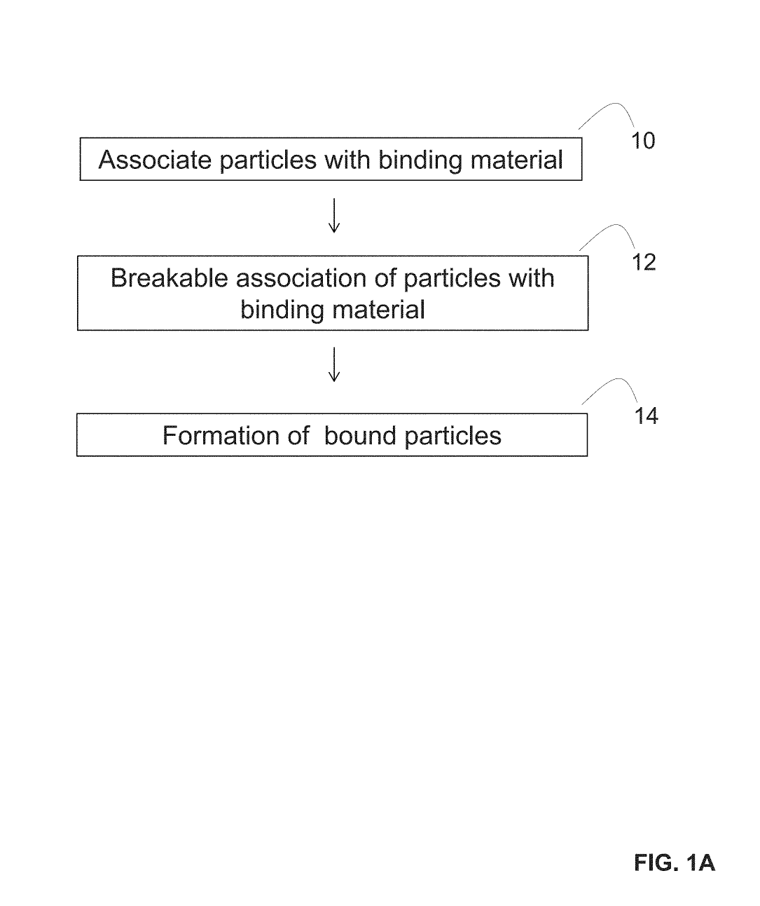

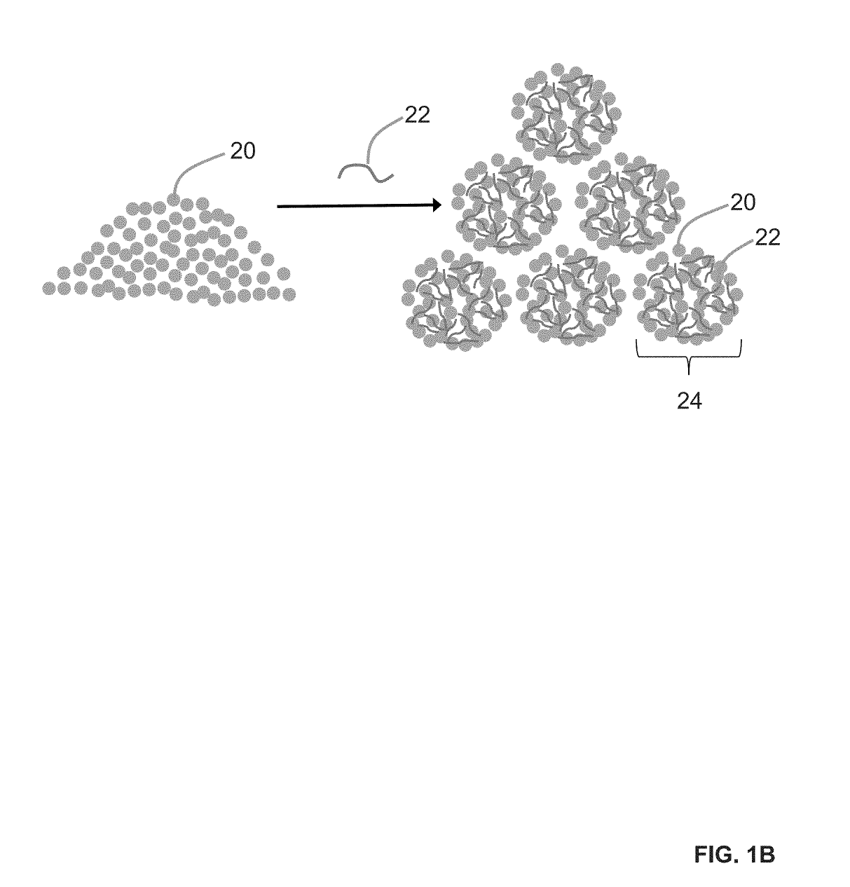

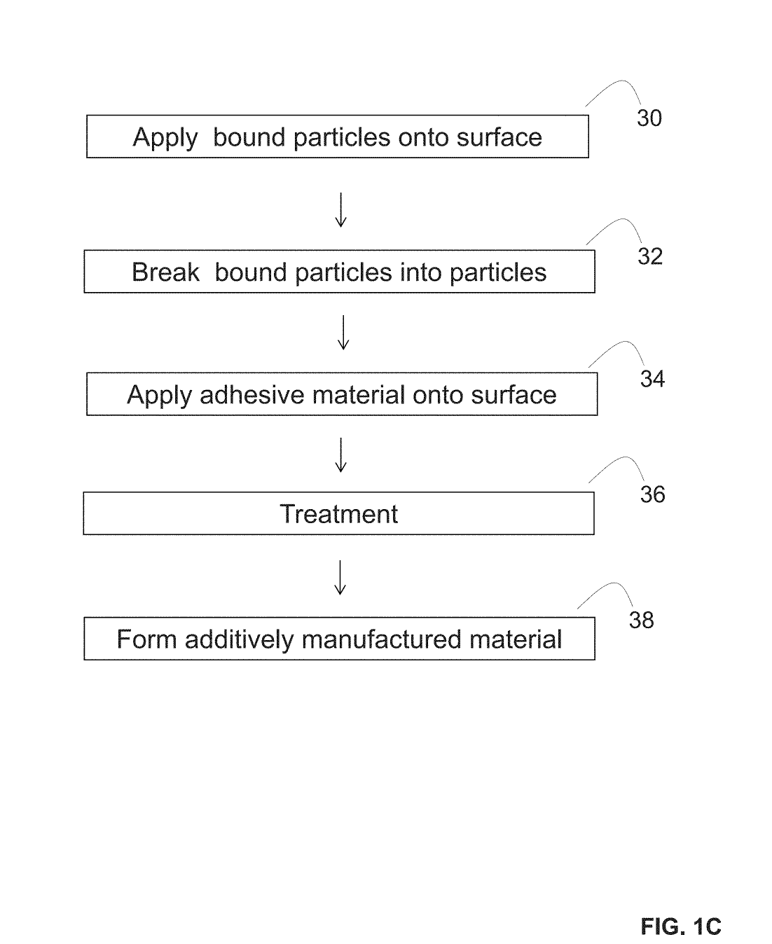

In some embodiments, the present disclosure pertains to methods of making a composition. In some embodiments illustrated in FIGS. 1A and 1B, the methods of the present disclosure include a step of associating particles 20 with a binding material 22 (step 10) such that particles 20 and binding material 22 become breakably associated with one another (step 12) and thereby form bound particles 24 (step 14).

In additional embodiments, the present disclosure pertains to the formed compositions. In some embodiments illustrated in FIG. 1B, the formed compositions include particles 20 (e.g., particles with diameters of less than about 1 μm) and binding material 22. The binding material and at least some of the particles are breakably associated with one another to form bound particles 24 (e.g., particles with diameters of more than about 1 μm).

In further embodiments, the present disclosure pertains to methods of additively manufacturing a material on a surface. In some embodiments illustrated in FIG. 1C, such methods include applying bound particles onto the surface, where the bound particles include particles breakably associated with one another through binding materials (step 30); breaking at least some of the bound particles into particles (step 32); applying an adhesive material onto the surface (step 34); and treating the particles and any remaining bound particles (step 36) to form the additively manufactured material (step 38). Additional embodiments of the present disclosure pertain to the formed additively manufactured materials.

As set forth in more detail herein, the present disclosure can have various embodiments. In particular, the compositions and methods of the present disclosure may utilize various particles and binding materials that become breakably associated with one another in various manners to form various types of bound particles. Furthermore, various methods may be utilized to associate particles with binding materials to breakably associate them with one another. Likewise, the additive manufacturing methods of the present disclosure may utilize various processes to form various types of additively manufactured materials.

Particles

The present disclosure can utilize various types of particles with various sizes. For instance, in some embodiments, the particles include diameters of less than about 1 μm. In some embodiments, the particles include diameters between about 100 nm to about 1 μm. In some embodiments, the particles include diameters between about 300 nm to about 1 μm. In some embodiments, the particles include diameters between about 1 nm to about 500 nm. In some embodiments, the particles include diameters between about 1 nm to about 300 nm. In some embodiments, the particles include diameters between about 1 nm to about 100 nm. In some embodiments, the particles include diameters of about 300 nm.

The present disclosure can utilize various types of particles. For instance, in some embodiments, the particles of the present disclosure include ceramic particles. In some embodiments, the ceramic particles include, without limitation, aluminum-based particles, zirconium-based particles, calcium-based particles, barium-based particles, silicon-based particles, titanium-based particles, oxide-based particles, carbide-based particles, nitride-based particles, boride-based particles, silicide-based particles, and combinations thereof. In some embodiments, the particles include aluminum-based particles, such as alumina particles.

In some embodiments, the particles include metal-based particles. In some embodiments, the particles include polymer-based particles. In some embodiments, the particles include oxide-based particles. The use of additional particles can also be envisioned.

Binding Materials

Binding materials generally refer to materials that are capable of breakably associating particles to one another. The present disclosure can utilize various types of binding materials. For instance, in some embodiments, the binding materials include, without limitation, glues, adhesives, thickeners, cement, gypsum, liquid glass, polymer-based binding materials, and combinations thereof.

In some embodiments, the binding materials include polymer-based binding materials. In some embodiments, the polymer-based binding materials include, without limitation, polyvinyl alcohol (PVA), polyisobutylene, polystyrenes, polybutadienes, and combinations thereof. In some embodiments, the binding material includes polyvinyl alcohol (PVA). In some embodiments, the binding material includes carbohydrates. In some embodiments, the binding material includes acrylic acid. The use of additional binding materials can also be envisioned.

Breakable Association of Particles and Binding Materials

Various methods may be utilized to breakably associate particles and binding materials. For instance, in some embodiments, the associating occurs by a method that includes, without limitation, mixing, grinding, milling, spray drying, spray freeze drying, and combinations thereof. In some embodiments, the associating occurs by mixing. In some embodiments, the associating occurs by grinding, such as grinding in a pestle and mortar. In some embodiments, the associating occurs by spray drying. In some embodiments, the associating occurs by spray binding. In some embodiments, the associating occurs by spray freeze binding. In some embodiments, the associating occurs by freeze binding. The use of additional association methods can also be envisioned.

Particles and binding materials can become breakably associated with one another at various weight ratios. For instance, in some embodiments, the particle to binder weight ratio is about 99:1. In some embodiments, the particle to binder weight ratio is about 5:1. In some embodiments, the particle to binder weight ratio is about 2:1. In some embodiments, the particle to binder weight ratio is about 1:1. Additional particle to binder weight ratios can also be envisioned.

The breakable association of particles and binding materials generally refers to the reversible association of particles and binding materials. The binding materials and particles of the present disclosure may become breakably associated with one another in various manners. For instance, in some embodiments, the binding material and at least some of the particles become breakably associated with one another through one or more interactions that include, without limitation, non-covalent interactions, ionic interactions, van der Waals forces, electrostatic interactions, London dispersion forces, π-π stacking interactions, and combinations thereof. In some embodiments, the binding material and at least some of the particles become breakably associated with one another through non-covalent interactions.

In some embodiments, the binding material and particles of the present disclosure become breakably associated with one another such that an external pressure or force dissociates at least some of the bound particles. In some embodiments, the external pressure or force includes pressure or force from a roller.

In some embodiments, the force of a roller that applies an external pressure or force on bound particles are controlled by various parameters. In some embodiments, the parameters include, without limitation, the roller diameter, the roller rotation speed, the roller translational speed, and combinations thereof.

In some embodiments, the external pressure or force includes pressure or force from a plate. In some embodiments, a roller and a plate can be utilized together to dissociate at least some of the bound particles from one another. In some embodiments, the application of the roller and the plate can make a powder bed denser. In some embodiments, multiple cycles of roller or plate pressing can be applied to make the powder bed denser.

Bound Particles

Bound particles generally refer to a plurality of particles that are breakably associated with one another by binding materials. The particles and binding materials of the present disclosure become breakably associated with one another to form various types of bound particles with various shapes and sizes.

The bound particles of the present disclosure can include various sizes. For instance, in some embodiments, the bound particles have diameters that are greater than about 1 μm. In some embodiments, the bound particles have diameters ranging from about 1 μm to about 500 μm. In some embodiments, the bound particles have diameters ranging from about 1 μm to about 300 μm. In some embodiments, the bound particles have diameters ranging from about 1 μm to about 150 μm. In some embodiments, the bound particles have diameters ranging from about 1 μm to about 100 μm. In some embodiments, the bound particles have diameters ranging from about 75 μm to about 90 μm. In some embodiments, the bound particles have diameters of about 88 μm.

The bound particles of the present disclosure can also have various shapes. For instance, in some embodiments, the bound particles are loosely agglomerated to one another. In some embodiments, the bound particles have circular shapes. In some embodiments, the bound particles have spherical shapes. In some embodiments, the bound particles have oval shapes. In some embodiments, the bound particles have satellite structures.

Formed Compositions

The compositions of the present disclosure can have various shapes and structures. For instance, in some embodiments, the compositions of the present disclosure include a hierarchical structure that includes particles and bound particles. In some embodiments, the particles in the composition provide high sinterability while the bound particles in the composition provide high flowability.

In some embodiments, the high sinterability of the particles of the present disclosure is defined by sintered densities of larger than 90%. In some embodiments, the high flowability of the bound particles of the present disclosure is defined by the ability of the bound particles to pass through an opening (e.g., Φ2.54 mm) in a facile manner.

In some embodiments, the compositions of the present disclosure have a granulated structure. In some embodiments, the compositions of the present disclosure include a mesh-like structure.

In some embodiments, the compositions of the present disclosure include a porous structure. In some embodiments, the compositions of the present disclosure include a plurality of micropores. In some embodiments, the compositions of the present disclosure include a plurality of macropores. In some embodiments, the compositions of the present disclosure include a plurality of mesopores. In some embodiments, the compositions of the present disclosure include a plurality of micropores and mesopores. In some embodiments, the compositions of the present disclosure include a plurality of macropores, micropores and mesopores.

Use of Compositions in Additive Manufacturing

In some embodiments, the compositions of the present disclosure can be utilized for additively manufacturing materials on a surface. In some embodiments, the additive manufacturing process includes binder jetting. In some embodiments illustrated in FIG. 1C, the additive manufacturing methods include applying bound particles onto the surface, where the bound particles include particles breakably associated with one another through binding materials (step 30); breaking at least some of the bound particles into particles (step 32); applying an adhesive material onto the surface (step 34); and treating the particles and any remaining bound particles (step 36) to form additively manufactured materials (step 38). As set forth in more detail herein, the additive manufacturing methods of the present disclosure can have various embodiments.

Applying Bound Particles onto a Surface

Bound particles may be applied onto a surface in various manners. For instance, in some embodiments, the bound particles are applied onto the surface by rolling the bound particles onto the surface. In some embodiments, the bound particles are applied onto the surface by scraping the bound particles onto the surface. In some embodiments, the bound particles are applied onto a surface by spraying the bound particles onto the surface. Additional application methods can also be envisioned.

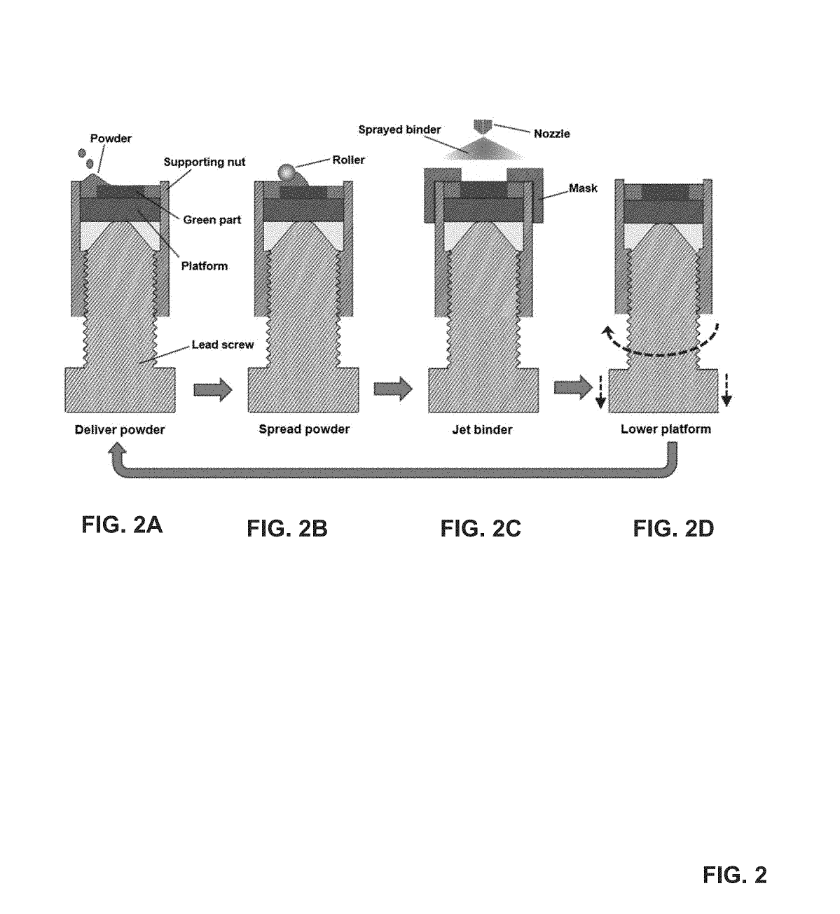

Furthermore, the bound particles of the present disclosure may be applied onto various surfaces. For instance, in some embodiments, the surface is a platform (e.g., a platform shown in FIG. 2). The utilization of additional surfaces can also be envisioned.

Breaking at Least Some of the Bound Particles into Particles

Various methods may also be utilized to break at least some of the bound particles into particles. For instance, in some embodiments, the breaking occurs after the bound particles are applied onto the surface. In some embodiments, the breaking occurs while the bound particles are applied onto the surface.

In some embodiments, the breaking step occurs during the applying step. In some embodiments, the breaking step is separate from the applying step. For instance, in some embodiments, the breaking step involves a separate step of agitating the bound particles.

In some embodiments, the breaking step breaks some of the bound particles into particles. In some embodiments, the breaking step breaks a majority of the bound particles into particles (e.g., 85% to 99%). In some embodiments, the breaking step breaks more than 99% of the bound particles into particles. In some embodiments, the breaking step breaks all of the bound particles into particles.

Applying an Adhesive Material onto the Surface

Adhesive materials generally refer to materials that can bind particles to one another. In some embodiments, the binding occurs irreversibly.

The methods of the present disclosure may utilize various types of adhesive materials. In some embodiments, the adhesive material is a three-dimensional printer adhesive, such as a glue. In some embodiments, the adhesive material includes one or more binding materials that were described previously. Additional adhesive materials can also be envisioned.

Various methods may also be utilized to apply adhesive materials onto a surface. For instance, in some embodiments, the adhesive material is applied by an inkjet print head. In some embodiments, the adhesive material is applied onto the surface by spray drying the adhesive material onto the surface. Additional application methods can also be envisioned.

Treating

Various methods may also be utilized to treat particles and any remaining bound particles. For instance, in some embodiments, the treating step includes, without limitation, curing, debinding, sintering, and combinations thereof.

In some embodiments, the treating step includes curing the particles, any remaining bound particles and binding material, and the adhesive material. In some embodiments, the curing includes heating the particles and any remaining bound particles. In some embodiments, the heating occurs at temperatures of at least about 100° C. In some embodiments, the heating occurs at temperatures of at least about 200° C.

In some embodiments, the treating step includes debinding the particles, any remaining bound particles and binding material, and the adhesive material. In some embodiments, the debinding includes heating the particles, any remaining bound particles and binding material, and the adhesive material at gradually increasing temperatures. In some embodiments, the gradually increasing temperatures range from about 200° C. to about 600° C. In some embodiments, the gradually increasing temperatures range from about 350° C. to about 550° C. In some embodiments, the gradually increasing temperatures are increased at a rate of about 1° C. per minute.

In some embodiments, the treating step includes sintering the particles. In some embodiments, the sintering includes heating the particles at temperatures of at least about 600° C. In some embodiments, the sintering includes heating the particles at temperatures of at least about 1,000° C. In some embodiments, the sintering includes heating the particles at temperatures of at least about 1,500° C.

Additively Manufactured Materials

The additive manufacturing methods of the present disclosure can be utilized to form various types of additively manufactured materials. Additional embodiments of the present disclosure pertain to the additively manufactured materials.

In some embodiments, the additively manufactured materials include a densely sintered body without visible pores or cracks. In some embodiments, the additively manufactured materials include pores that are less than about 1 μm in diameter. In some embodiments, the additively manufactured materials include a relative sintered density of at least about 80%. In some embodiments, the additively manufactured materials include a relative sintered density of at least about 85%. In some embodiments, the additively manufactured materials include a relative sintered density of at least about 88%.

In some embodiments, the additively manufactured materials include a sintered density of at least about 3 g/cm³. In some embodiments, the additively manufactured materials include a relative sintered density of at least about 3.5 g/cm³.

In some embodiments, the additively manufactured materials include a hardness of at least about 10 GPa. In some embodiments, the additively manufactured materials include a hardness of at least about 15 GPa.

Applications and Advantages

The present disclosure can provide various advantages. For instance, the compositions of the present disclosure can be utilized in accordance with the additive manufacturing methods of the present disclosure to make ceramic parts of complex shapes and varying materials, which may have been traditionally challenging to manufacture. In some embodiments, such ceramic parts can be manufactured with high sintered density and hardness in an economical and personalized manner for various applications, such as joint implants with tailored geometries and aerospace components with high performance at high temperature. As such, the present disclosure can be utilized to significantly benefit various industries, such as the biomedical and aerospace industries.

In some embodiments, the methods and compositions of the present disclosure can be utilized to make joint implants. Almost 2.9 million joint replacement surgeries happen each year worldwide. Currently, most joint implants are made from polymers and metals. There are two major shortcomings with polymeric and metallic joint implants: (1) polymeric wear debris can result in death of the adjacent bone cells and thus implant loosening; and (2) wear of metal implants can increase the concentration of metal ions, inducing dramatic necrotic and inflammatory changes in tissues surrounding the implants.

Furthermore, current manufacturing methods for nearly all ceramic implants involve forming of oversized parts followed by machining. Moreover, drawbacks of these methods include high consumption of time, materials, tooling, and energy. These drawbacks hinder the widespread application of ceramic implants.

The aforementioned shortcomings can be overcome by using ceramic joint implants that are fabricated in accordance with the methods and compositions of the present disclosure. For instance, the methods of the present disclosure can be utilized to produce patient-specific implants with customized geometries and tailored structures, such as spatially gradient porosity for varying material properties.

In additional embodiments, the methods and compositions of the present disclosure can be utilized to make certain key components for the aerospace industry. In particular, certain key components in the aerospace industry require extremely high service temperature, such as the leading edges of hypersonic vehicles, missile nose cones, and nozzle throat inserts for spacecraft propulsion systems. In some embodiments, the compositions of the present disclosure can be utilized to meet these demanding requirements.

### Additional Embodiments

Reference will now be made to more specific embodiments of the present disclosure and experimental results that provide support for such embodiments. However, Applicants note that the disclosure herein is for illustrative purposes only and is not intended to limit the scope of the claimed subject matter in any way.

### Example 1. Hierarchical Granules as Feedstock for Three-Dimensional Printing of Ceramics

This Example presents a new method to fabricate ceramic parts with binder jetting additive manufacturing using a novel granulated powder as feedstock. The granulated powder has a hierarchical structure, which consists of micron-sized (e.g., −170 mesh, <88 μm) granules assembled from submicron particles (e.g., ˜300 nm). Submicron constituent particles provide high sinterability due to their high specific surface energy, while the micron-sized assembled granules offer high flowability. Both sinterability and flowability of feedstock powder are keys to producing high-quality parts with binder jetting additive manufacturing.

A relative sintered density of 88% and a hardness of 15.6 GPa were achieved using the granulated powder. For comparison, parts from unstructured coarse (70 μm) and fine (300 nm) powders resulted in relative sintered densities of 61% and 77%, respectively. The part from the coarse powder was very brittle and that from the fine powder contained a significant number of pores and cracks, both of which would result in poor mechanical properties. As such, it is envisioned that the large difference in density is due to the entirely different granule structures.

For comparison, three kinds of powder (i.e. an unstructured coarse powder, an unstructured fine powder, and the hierarchically structured granulated powder developed in this Example), were used as feedstock materials for binder jetting. The morphologies of the feedstock materials were analyzed. The sintered density, the microstructure, and the hardness of the samples were also evaluated.

### Example 1.1. Materials

Alumina powder with an average particle size of 300 nm was purchased from Allied High Tech and used as the fine powder for comparison. It was also used as the raw material to prepare the granulated powder. Alumina powder with an average particle size of 70 μm was purchased from Inframat Advanced and used as the coarse powder for comparison. The granulation binder, polyvinyl alcohol (PVA) was purchased from Sigma-Aldrich.

### Example 1.2. Preparation of Granulated Powder

Key terminologies used for preparation of granulated powders are schematically shown in FIG. 1B. A particle means a small (e.g., nm) piece of a homogeneous material. A granule is an assembly of multiple particles with a secondary binder. The raw powder is composed of numerous particles while the granulated powder consists of numerous granules.

Feedstock preparation is a granulation process to convert raw powder to granulated powder by mixing the raw ceramic powder with an organic binder and forming particles into granules of suitable size (e.g., tens of microns).

An aqueous solution containing 3 wt. % PVA was prepared. The raw powder and the binder solution were mixed in a commercially available pestle and mortar set (213Y5, Karter Scientific) to achieve a desired alumina-to-PVA weight ratio of 99:1. The mixture was dried on a hot plate at 200° C., ground in the pestle and mortar, and sieved with a No. 170 mesh (88 μm) to obtain the granulated powder.

### Example 1.3. Binder Jetting

The binder jetting experiments were carried out using a lab-designed setup. The process is illustrated in FIG. 2. The process starts with powder delivering (FIG. 2A). Next, the powder is spread using a roller (FIG. 2B). Thereafter, the powder bed is covered by a mask with an opening corresponding to the cross section of the desired part (FIG. 2C). A specific amount of printing binder is then sprayed on the exposed powder (FIG. 2C), followed by removing the mask (FIG. 2D). Next, the platform is lowered by a predetermined layer thickness by rotating the lead screw. This process is repeated until an entire green part is printed. Discs with a diameter of 10 mm and a thickness of 1.6 mm were printed from both the granulated and raw powders under the same conditions. A layer thickness of 130 μm was used. The printing binder was also a PVA solution with a 1 wt. % concentration. About 0.65 g of the binder was applied for 1 g of the powder.

### Example 1.4. Post-Processing

After printing, a curing step was applied. The samples were placed in a low-temperature furnace (KSL-1100X-S-UL-LD, MTI Corporation, CA) at 200° C. for 2 hours to evaporate the water in the binder and join the particles. After naturally cooling down, the green bodies were carefully extracted from the powder bed and positioned to a high-temperature furnace (HTF 18/4, Carbolite Gero Ltd., Germany) for debinding and sintering. Debinding profile was selected based on the Differential Scanning calorimetry (DSC) analysis of the powder.

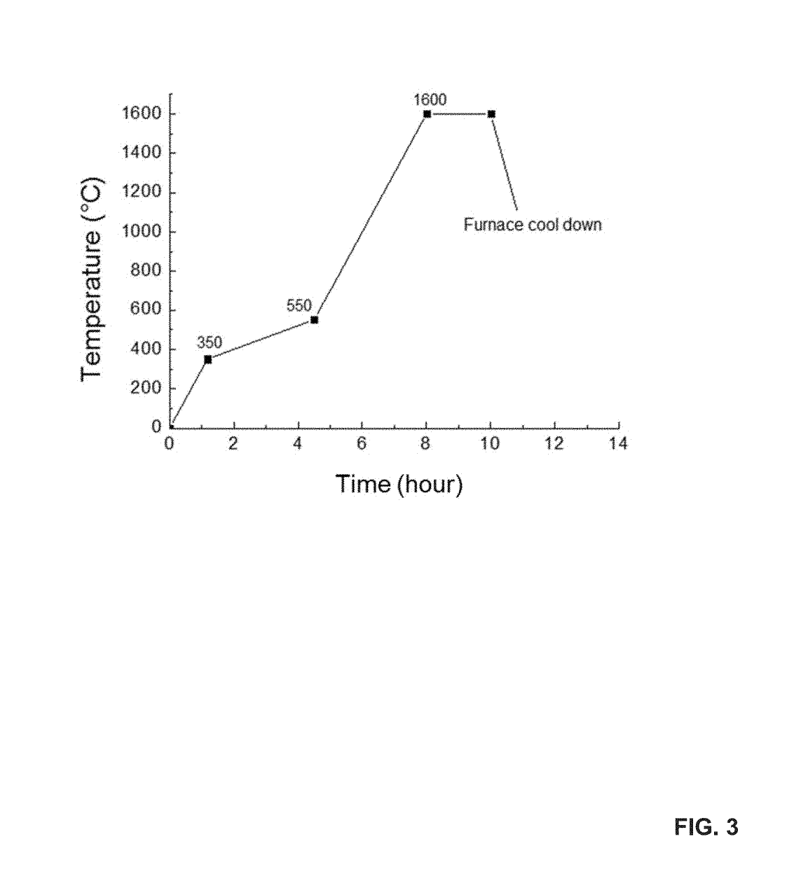

The debinding and sintering profile is shown in FIG. 3. Specifically, the furnace temperature was increased to 350° C. with a ramp-up rate of 5° C./minute, followed by the debinding process from 350° C. to 550° C. with a ramp-up rate of 1° C./minute. Then the furnace was heated up to 1,600° C. at 5° C./minute and then dwelled 2 hours for the sintering process, after which the samples were left in the furnace until it cooled down to room temperature. All of these post-processing procedures happened in air atmosphere

### Example 1.5. Density Measurement, Microstructural Characterization, and Hardness Testing

Density of the sintered samples was measured with modified Archimedes' method (coating a thin hydraulic layer on the surface). After the dry mass (m_{d}) of a sample was measured, the sample was carefully lowered onto a pan suspended in a beaker of deionized water to determine its wet mass (m_{w}). The mass measurements were done using an analytical balance (AGCN200, Torbal, N.Y.) with an accuracy of 0.1 mg. The dry and wet masses were then used to calculate the density with the knowledge of density of water in accordance with Equation 1:

$${ρ}_{sp} = {ρ}_{wt} \frac{{m}_{d}}{{m}_{d} - {m}_{w}} \qquad Eq . 1$$

In Equation 1, ρₛₚ and ρ_{wt} are the densities of the sample and water, respectively. If a sample has a high porosity, the water infiltrates the sample and thus the above method overestimates the density. All samples were coated with an extremely thin layer of paint to eliminate the water infiltration.

The morphology of the powders and the microstructure of the sintered samples were characterized using Scanning Electron Microscopy (SEM) (TESCAN VEGA II LSU, Brno-Kohoutovice, Czech).

A micro hardness tester (Wilson VH1102, Illinois Tool Works Inc., IL) was used to test the hardness using a load of 1 kgf and a dwell time of 15 seconds according to ASTM standard [34]. The hardness was tested on a ground and polished surface.

### Example 1.6. Characteristics of Powders

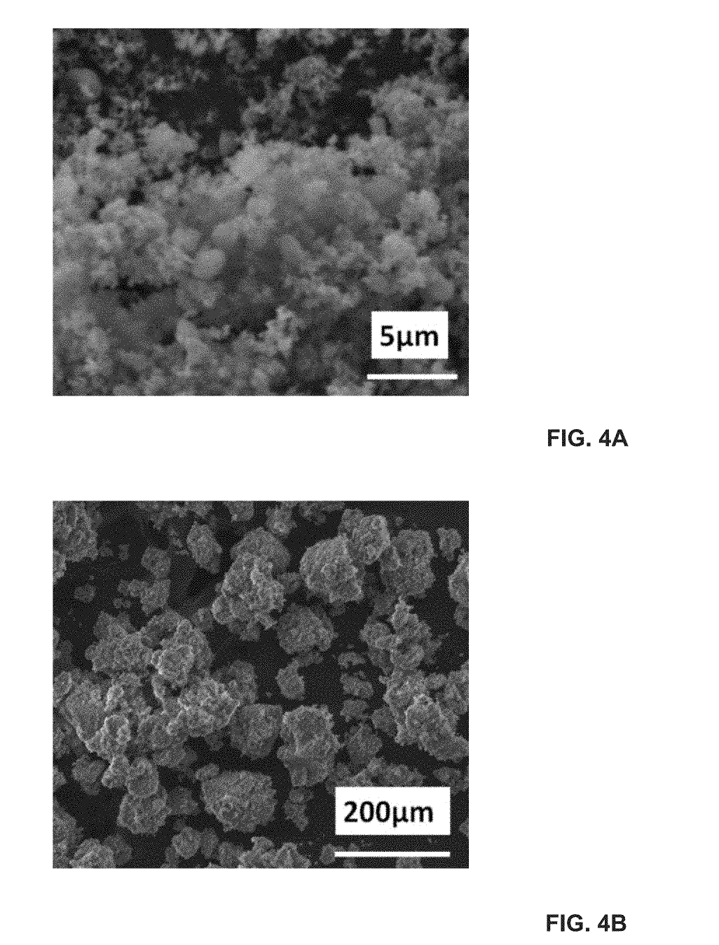

FIGS. 4A-4B show the morphologies of the fine powder (FIG. 4A) and the granulated powder (FIG. 4B). The fine powder consists of submicron particles of irregular shapes. The granulation process successfully joined the fine particles with the PVA binder, from which equiaxed granules were obtained.

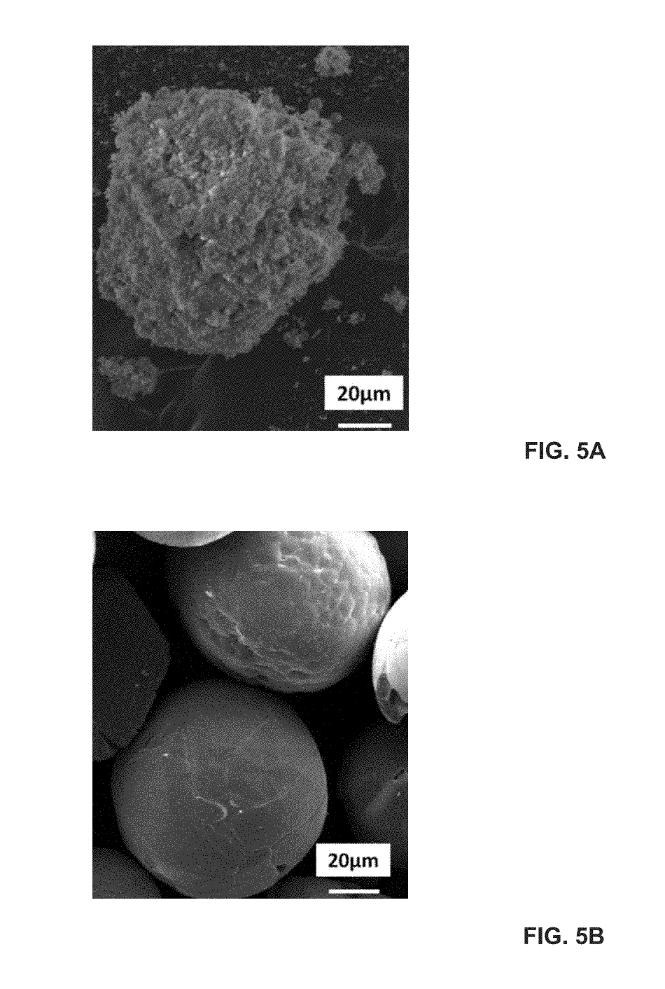

FIGS. 5A-5B show a comparison of the morphologies between the granulated powder (FIG. 5A) and the coarse powder (FIG. 5B). The granule has a similar size with the particles in the coarse powder. The hierarchical internal structure of the granulated powder can be identified as well in the micrograph.

### Example 1.7. Density, Microstructure and Hardness of Sintered Samples

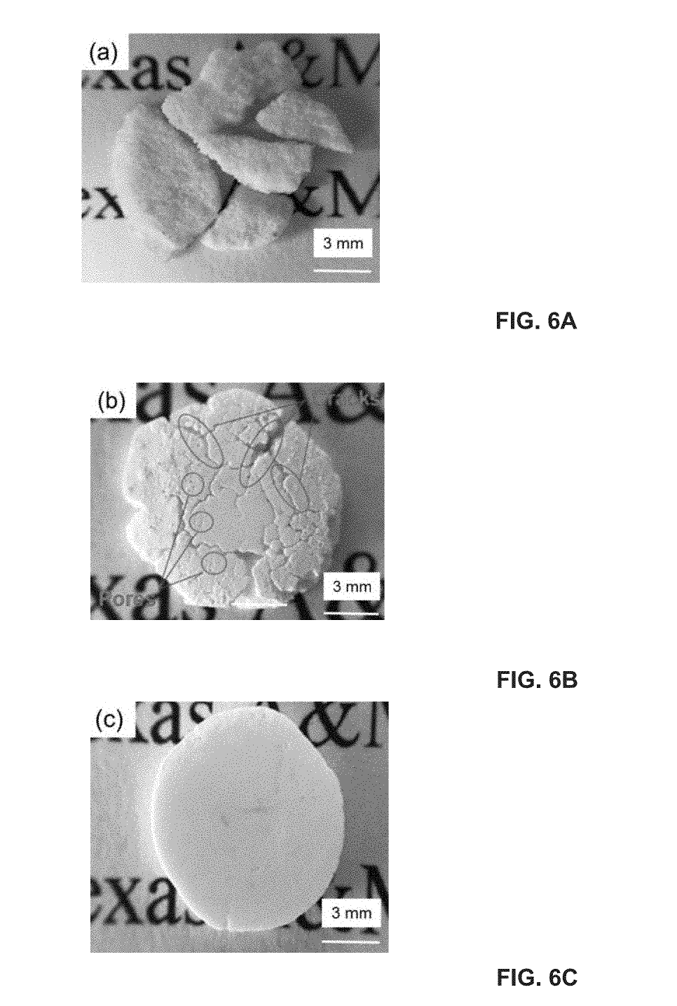

FIGS. 6A-6C show the appearances of the sintered samples, which are three disks made with the coarse (FIG. 6A), fine (FIG. 6B), and granulated powders (FIG. 6C), respectively. The sample made with the granulated powder had a smooth surface and a densely sintered body without visible pores or cracks. The sample from the coarse powder was brittle since the particles were only loosely sintered due to the low sinterability. For the sample from the fine powder, a lot of pores and cracks were developed in the body. The defects are mostly likely because of the low flowability of the fine powder. It was observed that the powder bed from the fine powder contained voids, which are believed to develop into the voids in the sintered part. The reason for the crack formation is considered as the nonuniform powder spreading and thus uneven shrinkage during sintering.

The relative sintered density is presented in Table 2. The sample from the granulated powder has the largest sintered density. The part from the coarse powder has the smallest density. The relative sintered density of part from the fine powder is 11% less than that from the granulated powder since there are significant pores and cracks in the sample.

TABLE 2
Density of sintered samples.

| | | Relative sintered |
|---|---|---|
| Material | Sintered density (g/cm³) | density (%) [35] |
| Coarse powder | 2.39 | 61 |
| Fine powder | 3.06 | 77 |
| Granulated powder | 3.48 | 88 |

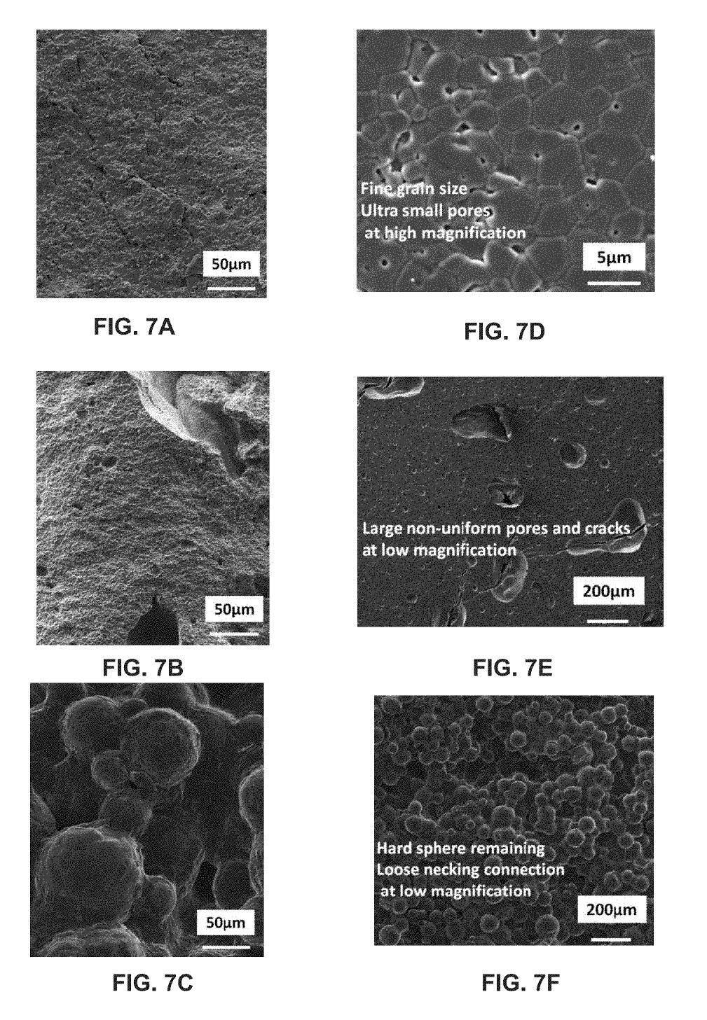

FIGS. 7A-7F show the completely different microstructures of sintered samples from the granulated powder, the fine powder, and the coarse powder. The sample made with the granulated powder showed a typical transcrystalline fracture morphology (FIG. 7A). A polished surface morphology of this sample under a higher magnification is shown in FIG. 7D, which demonstrates a high sintering quality with tiny pores (<1 μm) remaining. The dense and uniform sintered microstructure also indicates a complete crushing of the granules. The average grain size of this sample was below 5 μm. This fine microstructure often leads to good mechanical properties for structural ceramics.

A large number of pores and cracks of various sizes are randomly distributed in the sintered sample from the fine powder (FIGS. 7B and 7E), which resulted from the non-uniform powder spreading during printing due to the low flowability. The coarse powder was not densely sintered (FIGS. 7C and 7F) under the same conditions due to the low specific surface area and thus low sintering activity. The large spheres were only loosely connected by the necking formed at the high temperature. FIG. 7F shows the morphology under a lower magnification. Pores and cracks remained between the coarse spherical particles, which induced the low density.

The sample made with the granulated powder resulted in a hardness of 15.6 GPa, which is close to the reference value of the fine alumina for ceramic bearings (16 GPa) [35]. For the sample from the coarse powder, the body was too porous and brittle, which was crushed by the indenter, resulting in a nonstandard indentation with a diagonal length of about 1.5 mm. For the sample made with the fine powder, many randomly-located pores and cracks existed in the sample, which also made the hardness testing impossible.

In summary, granulated alumina powder was prepared by mixing a fine alumina powder (300 nm) with a PVA binder. The performance of this granulated powder for binder jetting was evaluated against traditional fine (300 nm) and coarse (70 μm) powders. SEM showed that the PVA binder successfully joined the fine alumina particles by the granulation process, resulting in the granules with a nearly spherical shape and an average size of about 70 μm. The samples from the three kinds of powders had different appearances after sintering. The sample from the granulated powder had a smooth surface and a dense body, while that from the raw powder was porous and brittle to handle and that from the fine powder developed a significant number of randomly-located pores and cracks in the sample.

In comparison of the density, the sample from the granulated powder achieved the highest relative sintered density (88%). SEM of sintered samples showed that the granulated powder was densely sintered and resulted in a typical transcrystalline fracture morphology, indicating a complete crushing of the granules and high sinterability. The coarse powder was only loosely sintered by forming necks between particles. Pores and cracks were formed in various sizes across the entire sample from the fine powder.

Only the sample from the granulated powder was suitable for hardness testing, which achieved a Vickers micro hardness of 15.6 GPa, which is comparable to that by traditional ceramic manufacturing processes. The innovative granulated powder solved the contradiction between flowability and sinterability, which provides a promising way to additively manufacture high-density ceramic parts and materialize industrial applications of ceramic additive manufacturing.

### Example 1.8. References

[1] Klocke, F., 1997, “Modern Approaches for the Production of Ceramic Components,” J. Eur. Ceram. Soc., 17(2-3), pp. 457-465.
[2] Srivatsan, T. S., Manigandan, K., and Sudarshan, T. S., 2015, “Additive Manufacturing of Materials: Viable Techniques, Metals, Advances, Advantages, and Applications,” Additive Manufacturing, CRC Press, pp. 1-48.
[3] Du, W., Ren, X., Ma, C., and Pei, Z., 2017, “Binder Jetting Additive Manufacturing of Ceramics: A Literature Review,” Proceedings of the ASME 2017 International Mechanical Engineering Congress and Exposition, Tampa, Fla., pp. 1-12.
[4] Gaytan, S. M., Cadena, M., Aldaz, M., Herderick, E., Medina, F., Wicker, R., and Keck, W. M., 2013, “Analysis of Ferroelectric Ceramic Fabricated by Binder Jetting Technology,” Proceedings of Solid Freeform Fabrication Symposium, Austin, pp. 859-868.
[5] Miyanaji, H., Zhang, S., Lassell, A., Zandinejad, A., and Yang, L., 2016, “Process Development of Porcelain Ceramic Material with Binder Jetting Process for Dental Applications,” JOM, 68(3), pp. 831-841.
[6] Fu, Z., Schlier, L., Travitzky, N., and Greil, P., 2013, “Three-Dimensional Printing of SiSiC Lattice Truss Structures,” Mater. Sci. Eng. A, 560, pp. 851-856.
[7] Melcher, R., Martins, S., Travitzky, N., and Greil, P., 2006, “Fabrication of Al2O3-Based Composites by Indirect 3D-Printing,” Mater. Lett., 60(4), pp. 572-575.
[8] Gonzalez, J. A., Mireles, J., Lin, Y., and Wicker, R. B., 2016, “Characterization of Ceramic Components Fabricated Using Binder Jetting Additive Manufacturing Technology,” Ceram. Int., 42, pp. 10559-10564.
[9] Du, W., Ren, X., Chen, Y., Ma, C., Radovic, M., and Pei, Z., 2018, “Model Guided Mixing of Ceramic Powders with Graded Particle Sizes in Binder Jetting Additive Manufacturing,” Proceedings of the ASME 2018 13th International Manufacturing Science and Engineering Conference, College Station, Tex., pp. 1-9.
[10] Du, W., Ren, X., Ma, C., and Pei, Z., 2019, “Ceramic Binder Jetting Additive Manufacturing: Particle Coating for Increasing Powder Sinterability and Part Strength,” Mater. Lett., 234, pp. 327-330.
[11] McEntire, B. J., Bal, B. S., Rahaman, M. N., Chevalier, J., and Pezzotti, G., 2015, “Ceramics and Ceramic Coatings in Orthopaedics,” J. Eur. Ceram. Soc., 35(16), pp. 4327-4369.
[12] Utela, B., Anderson, R. L., and Kuhn, H., 2006, “Advanced Ceramic Materials and Processes for Three-Dimensional Printing (3DP),” Solid Free. Fabr. Symp., pp. 290-303.
[13] Hotta, M., Shimamura, A., Kondo, N., and Ohji, T., 2016, “Powder Layer Manufacturing of Alumina Ceramics Using Water Spray Bonding,” J. Ceram. Soc. Japan, 124(6), pp. 750-752.
[14] Igawa, K., Mochizuki, M., Sugimori, O., Shimizu, K., Yamazawa, K., Kawaguchi, H., Nakamura, K., Takato, T., Nishimura, R., Suzuki, S., and Anzai, M., 2006, “Tailor-Made Tricalcium Phosphate Bone Implant Directly Fabricated by a Three-Dimensional Ink-Jet Printer,” J. Artif. Organs, 9(4), pp. 234-240.
[15] Khalyfa, A., Vogt, S., Weisser, J., Grimm, G., Rechtenbach, A., Meyer, W., and Schnabelrauch, M., 2007, “Development of a New Calcium Phosphate Powder-Binder System for the 3D Printing of Patient Specific Implants,” J. Mater. Sci. Mater. Med., 18(5), pp. 909-916.
[16] Gbureck, U., Hölzel, T., Biermann, I., Barralet, J. E., and Grover, L. M., 2008, “Preparation of Tricalcium Phosphate/Calcium Pyrophosphate Structures via Rapid Prototyping,” J. Mater. Sci. Mater. Med., 19(4), pp. 1559-1563.
[17] Birkholz, M. N., Agrawal, G., Bergmann, C., Schroder, R., Lechner, S. J., Pich, A., and Fischer, H., 2015, “Calcium Phosphate/Microgel Composites for 3D Powderbed Printing of Ceramic Materials,” Biomed. Tech., 61(3), pp. 267-279.
[18] Gaytan, S. M., Cadena, M. A., Karim, H., Delfin, D., Lin, Y., Espalin, D., MacDonald, E., and Wicker, R. B., 2015, “Fabrication of Barium Titanate by Binder Jetting Additive Manufacturing Technology,” Ceram. Int., 41(5), pp. 6610-6619.
[19] Yin, X., Travitzky, N., and Greil, P., 2007, “Three-Dimensional Printing of Nanolaminated Ti3AlC2 Toughened TiAl3-Al2O3 Composites,” J. Am. Ceram. Soc., 90(7), pp. 2128-2134.
[20] Melcher, R., Travitzky, N., Zollfrank, C., and Greil, P., 2011, “3D Printing of Al2O3/Cu—O Interpenetrating Phase Composite,” J. Mater. Sci., 46(5), pp. 1203-1210.
[21] Maleksaeedi, S., Eng, H., Wiria, F. E., Ha, T. M. H., and He, Z., 2014, “Property Enhancement of 3D-Printed Alumina Ceramics Using Vacuum Infiltration,” J. Mater. Process. Technol., 214(7), pp. 1301-1306.
[22] Mehrban, N., Bowen, J., Vorndran, E., Gbureck, U., and Grover, L. M., 2013, “Structural Changes to Resorbable Calcium Phosphate Bioceramic Aged in Vitro,” Colloids Surfaces B Biointerfaces, 111, pp. 469-478.
[23] Tamimi, F., Torres, J., Al-Abedalla, K., Lopez-Cabarcos, E., Alkhraisat, M. H., Bassett, D. C., Gbureck, U., and Barralet, J. E., 2014, “Osseointegration of Dental Implants in 3D-Printed Synthetic Onlay Grafts Customized According to Bone Metabolic Activity in Recipient Site,” Biomaterials, 35(21), pp. 5436-5445.
[24] Tamimi, F., Torres, J., Gbureck, U., Lopez-Cabarcos, E., Bassett, D. C., Alkhraisat, M. H., and Barralet, J. E., 2009, “Craniofacial Vertical Bone Augmentation: A Comparison between 3D Printed Monolithic Monetite Blocks and Autologous Onlay Grafts in the Rabbit,” Biomaterials, 30(31), pp. 6318-6326.
[25] Travitzky, N., Zimmermann, K., Melcher, R., and Greil, P., 2006, “From Polysaccharides to SiSiC Composites by 3d Printing,” pp. 37-45.
[26] Yin, X., Travitzky, N., and Greil, P., 2007, “Near-Net-Shape Fabrication of Ti3AlC2-Based Composites,” Int. J. Appl. Ceram. Technol., 4(2), pp. 184-190.
[27] Nan, B., Yin, X., Zhang, L., and Cheng, L., 2011, “Three-Dimensional Printing of Ti3SiC2-Based Ceramics,” J. Am. Ceram. Soc., 94(4), pp. 969-972.
[28] Leukers, B., Gülkan, H., Irsen, S., and Milz, S., 2005, “Hydroxyapatite Scaffolds for Bone Tissue Engineering Made by 3D Printing,” J. Mater. Sci. Mater. Med., 6, pp. 1121-1124.
[29] Seitz, H., Deisinger, U., Leukers, B., Detsch, R., and Ziegler, G., 2009, “Different Calcium Phosphate Granules for 3-D Printing of Bone Tissue Engineering Scaffolds,” Adv. Eng. Mater., 11(5), pp. 41-46.
[30] Gildenhaar, R., Knabe, C., Gomes, C., Linow, U., Houshmand, A., and Berger, G., 2011, “Calcium Alkaline Phosphate Scaffolds for Bone Regeneration 3D-Fabricated by Additive Manufacturing,” Key Eng. Mater., 493, pp. 849-854.
[31] Zocca, A., Gomes, C. M., Bernardo, E., Muller, R., Gunster, J., and Colombo, P., 2013, “LAS Glass-Ceramic Scaffolds by Three-Dimensional Printing,” J. Eur. Ceram. Soc., 33(9), pp. 1525-1533.
[32] Cox, S. C., Thornby, J. A., Gibbons, G. J., Williams, M. A., and Mallick, K. K., 2015, “3D Printing of Porous Hydroxyapatite Scaffolds Intended for Use in Bone Tissue Engineering Applications,” Mater. Sci. Eng. C, 47, pp. 237-247.
[33] Ben, Y., Zhang, L., Wei, S., Zhou, T., Li, Z., Yang, H., Wang, Y., Selim, F. A., Wong, C., and Chen, H., 2017, “PVB Modified Spherical Granules of β-TCP by Spray Drying for 3D Ceramic Printing,” J. Alloys Compd., 721, pp. 312-319.
[34] ASTM International, 2003, “C1327-03: Standard Test Method for Vickers Indentation Hardness of Advanced Ceramics.”
[35] Somiya, S., 2003, Handbook of Advanced Ceramics: Processing and Their Applications, Elsevier/Academic Press.

Without further elaboration, it is believed that one skilled in the art can, using the description herein, utilize the present disclosure to its fullest extent. The embodiments described herein are to be construed as illustrative and not as constraining the remainder of the disclosure in any way whatsoever. While the embodiments have been shown and described, many variations and modifications thereof can be made by one skilled in the art without departing from the spirit and teachings of the invention. Accordingly, the scope of protection is not limited by the description set out above, but is only limited by the claims, including all equivalents of the subject matter of the claims. The disclosures of all patents, patent applications and publications cited herein are hereby incorporated herein by reference, to the extent that they provide procedural or other details consistent with and supplementary to those set forth herein.

What is claimed is:

1. A composition comprising:
particles; and
a binding material,
wherein the binding material and at least some of the particles are breakably associated with one another to form bound particles.

2. The composition of claim 1, wherein the particles comprise ceramic particles.

3. The composition of claim 2, wherein the ceramic particles are selected from the group consisting of aluminum-based particles, zirconium-based particles, calcium-based particles, barium-based particles, silicon-based particles, titanium-based particles, oxide-based particles, carbide-based particles, nitride-based particles, boride-based particles, silicide-based particles, and combinations thereof.

4. The composition of claim 1, wherein the particles comprise diameters of less than about 1 μm.

5. The composition of claim 1, wherein the particles comprise diameters between about 300 nm to about 1 μm.

6. The composition of claim 1, wherein the binding material comprises polymer-based binding materials.

7. The composition of claim 1, wherein the binding materials is selected from the group consisting of polyvinyl alcohol (PVA), polyisobutylene, polystyrenes, polybutadienes, carbohydrates, acrylic acid, and combinations thereof.

8. The composition of claim 1, wherein the binding material and at least some of the particles are breakably associated with one another through one or more interactions selected from the group consisting of non-covalent interactions, ionic interactions, van der Waals forces, electrostatic interactions, London dispersion forces, π-π stacking interactions, and combinations thereof.

9. The composition of claim 1, wherein the bound particles comprise diameters of more than about 1 μm.

10. A method of additively manufacturing a material on a surface, said method comprising:
(a) applying bound particles onto the surface, wherein the bound particles comprise particles breakably associated with one another through binding materials;
(b) breaking at least some of the bound particles into particles;
(c) applying an adhesive material onto the surface; and
(d) treating the particles and any remaining bound particles to form the additively manufactured material.

11. The method of claim 10, wherein the bound particles are applied onto the surface by rolling or scraping the bound particles onto the surface.

12. The method of claim 10, wherein the breaking occurs after the bound particles are applied onto the surface.

13. The method of claim 10, wherein the breaking occurs while the bound particles are applied onto the surface.

14. The method of claim 10, wherein the breaking breaks a majority of the bound particles into particles.

15. The method of claim 10, wherein the adhesive material comprises a glue.

16. The method of claim 10, wherein the adhesive material is applied onto the surface with an inkjet print head.

17. The method of claim 10, wherein the treating comprises one or more methods selected from the group consisting of curing, debinding, sintering, and combinations thereof.

18. The method of claim 10,
wherein the treating comprises curing the particles, any remaining bound particles and binding material, and the adhesive material; and
wherein the curing comprises heating at temperatures of at least about 100° C.

19. The method of claim 10,
wherein the treating comprises debinding the particles, any remaining bound particles and binding material, and the adhesive material;
wherein the de-binding comprises heating the particles, any remaining bound particles and binding material, and the adhesive material at gradually increasing temperatures; and
wherein the gradually increasing temperatures range from about 200° C. to about 600° C.

20. The method of claim 10,
wherein the treating comprises sintering the particles; and
wherein the sintering comprises heating the particles at temperatures of at least about 600° C.

21. The method of claim 10, wherein the particles comprise ceramic particles selected from the group consisting of aluminum-based particles, zirconium-based particles, calcium-based particles, barium-based particles, silicon-based particles, titanium-based particles, oxide-based particles, carbide-based particles, nitride-based particles, boride-based particles, silicide-based particles, and combinations thereof.

22. The method of claim 10, wherein the binding material is selected from the group consisting of polyvinyl alcohol (PVA), polyisobutylene, polystyrenes, polybutadienes, carbohydrates, acrylic acid, and combinations thereof.

23. The method of claim 10, wherein the binding material and at least some of the particles are breakably associated with one another through one or more interactions selected from the group consisting of non-covalent interactions, ionic interactions, van der Waals forces, electrostatic interactions, London dispersion forces, π-π stacking interactions, and combinations thereof.

24. The method of claim 10, wherein the additively manufactured material comprises a relative sintered density of at least about 80%.

25. The method of claim 10, wherein the additively manufactured material comprises a sintered density of at least about 3 g/cm³.

26. The method of claim 10, wherein the additively manufactured material comprises a hardness of at least about 10 GPa.

27. A method of making a composition, said method comprising:
associating particles with a binding material,
wherein the binding material and at least some of the particles become breakably associated with one another to form bound particles.

28. The method of claim 27, wherein the associating occurs by a method selected from the group consisting of mixing, grinding, milling, spray drying, spray freeze drying, and combinations thereof.

29. The method of claim 27, wherein the particles comprise ceramic particles selected from the group consisting of aluminum-based particles, zirconium-based particles, calcium-based particles, barium-based particles, silicon-based particles, titanium-based particles, oxide-based particles, carbide-based particles, nitride-based particles, boride-based particles, silicide-based particles, and combinations thereof.

30. The method of claim 27, wherein the binding material is selected from the group consisting of polyvinyl alcohol (PVA), polyisobutylene, polystyrenes, polybutadienes, carbohydrates, acrylic acid, and combinations thereof.
